(19) United States
(12) Patent Application Publication
(10) Pub. No.: US 2025/0052871 A1
(43) Pub. Date: Feb. 13, 2025

(54) RANGING DEVICE

(71) Applicant: CANON KABUSHIKI KAISHA, Tokyo (JP)

(72) Inventor: YUUTA OOSHIMA, Saitama (JP)

(21) Appl. No.: 18/771,766

(22) Filed: Jul. 12, 2024

(30) Foreign Application Priority Data
Aug. 7, 2023 (JP) 2023-128388

(51) Int. Cl. G01S 7/4863; G01S 7/4865; G01S 17/10; G01S 17/931

(52) U.S. Cl. CPC G01S 7/4863; G01S 7/4865; G01S 17/10; G01S 17/931

(57) ABSTRACT

A ranging device includes: a time counting unit configured to output a time count value indicating an elapsed time from a start of time counting; a light receiving unit including a plurality of pixels and configured to output a light reception count value of incident light to each of the plurality of pixels; and a pixel information generation unit configured to output pixel information in which the light reception count value and the time count value are associated with each other for each pixel. The pixel information generation unit acquires the light reception count value of each of the plurality of pixels and outputs the pixel information of each of the plurality of pixels within a period of time equal to or less than a time in which the time count value changes by a predetermined value.

### BACKGROUND

### Field of the Invention

The present invention relates to a ranging device.

### Description of the Related Art

In International Publication No. WO2020/022137, a ranging device for measuring a distance to an object based on a flight time of light from when a light source emits light to when a pixel receives reflected light from the object is disclosed. The ranging device of International Publication No. WO2020/022137 includes a time-to-digital converter to which signals from a plurality of pixels are input, and a correction processing unit that corrects a delay time with a correction value corresponding to a position of the pixel.

Japanese Patent Application Laid-Open No. 2020-524258 discloses a ranging device in which a plurality of photodetectors and a plurality of registers corresponding to the photodetectors are arranged. Each of the plurality of registers holds data indicating the position of the register when incident light is detected. The plurality of registers is coupled to form a shift register. Each time a predetermined time elapses, the data in each register is shifted to the register of the address next to the right, thereby reading of the data is performed. The actual photon arrival time is calculated from the difference between the time when the data is moved to the rightmost address and the time when shifting of the data is performed.

A ranging device in which a time counting unit is shared by a plurality of pixels as in International Publication No. WO2020/022137 and Japanese Patent Application Laid-Open No. 2020-524258, information about incident light may be lost in a case where light enters a pixel in the period when the signal is being read. Therefore, reducing loss of information of incident light may be required.

An object of the present invention is to provide a ranging device capable of reducing loss of information of incident light.

### SUMMARY OF THE INVENTION

According to a disclosure of the present specification, there is provided a ranging device including: a time counting unit configured to output a time count value indicating an elapsed time from a start of time counting; a light receiving unit including a plurality of pixels and configured to output a light reception count value of incident light to each of the plurality of pixels; and a pixel information generation unit configured to output pixel information in which the light reception count value and the time count value are associated with each other for each pixel. The pixel information generation unit acquires the light reception count value of each of the plurality of pixels and outputs the pixel information of each of the plurality of pixels within a period of time equal to or less than a time in which the time count value changes by a predetermined value.

Further features of the present invention will become apparent from the following description of exemplary embodiments with reference to the attached drawings.

### BRIEF DESCRIPTION OF THE DRAWINGS

FIG. 1 is a hardware block diagram illustrating a schematic configuration example of a ranging device according to a first embodiment.

FIG. 2 is a functional block diagram illustrating a schematic configuration example of the ranging device according to the first embodiment.

FIG. 3 is a diagram schematically illustrating an operation of the ranging device in one ranging period according to the first embodiment.

FIGS. 4A, 4B, 4C, and 4D are histograms visually illustrating frequency distributions of pulse count values according to the first embodiment.

FIG. 5 is a diagram illustrating a configuration of a light receiving unit, a control unit, a time counting unit, and a pixel information generation unit according to the first embodiment.

FIGS. 6A, 6B, and 6C are diagrams illustrating the configuration and operation of the pixel according to the first embodiment.

FIG. 7 is a timing chart illustrating an operation of the ranging device according to the first embodiment.

FIG. 8 is a diagram illustrating a configuration of a light receiving unit, a control unit, a time counting unit, and a pixel information generation unit according to a second embodiment.

FIG. 9 is a timing chart illustrating an operation of the ranging device according to the second embodiment.

FIG. 10 is a diagram illustrating a configuration of a light receiving unit, a control unit, a time counting unit, and a pixel information generation unit according to a third embodiment.

FIG. 11 is a diagram illustrating a configuration of a light receiving unit, a control unit, a time counting unit, and a pixel information generation unit according to a fourth embodiment.

FIG. 12 is a diagram illustrating a configuration of a light receiving unit, a control unit, a time counting unit, and a pixel information generation unit according to a fifth embodiment.

FIG. 13 is a diagram illustrating a configuration of a light receiving unit, a control unit, a time counting unit, and a pixel information generation unit according to a sixth embodiment.

FIGS. 14A and 14B are schematic diagrams of equipment according to a seventh embodiment.

### DESCRIPTION OF THE EMBODIMENTS

Hereinafter, embodiments of the present invention will be described with reference to the drawings. The same or corresponding elements are denoted by the same reference numerals throughout the several drawings, and the description thereof may be omitted or simplified.

### First Embodiment

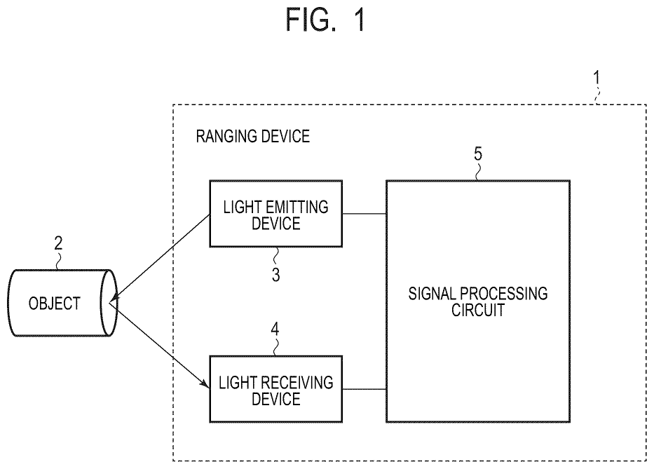

FIG. 1 is a hardware block diagram illustrating a schematic configuration example of a ranging device 1 according to the present embodiment. The ranging device 1 includes a light emitting device 3, a light receiving device 4, and a signal processing circuit 5. Note that the configuration of the ranging device 1 illustrated in the present embodiment is merely an example, and the embodiment is not limited to the illustrated configuration.

The ranging device 1 is a device that measures a distance to an object 2 to be measured using a technique such as light detection and ranging (LiDAR). The ranging device 1 measures a distance from the ranging device 1 to the object 2 based on a time difference from when the light is emitted from the light emitting device 3 to when the light is reflected by the object 2 and received by the light receiving device 4, that is, a time of flight (ToF) of the light.

One of the measurement methods in LiDAR is the direct time of flight (dToF) method. The dToF method is a method in which, for example, the elapsed time from light emission to light reception is directly measured by a time-to-digital converter or the like, and the distance is calculated from the elapsed time and the speed of light.

As a light emission method used for ranging of the dToF method, there are three methods, namely, a scan method, a sequential flash method, and a flash method. The scan method is a method of repeatedly performing a process of ranging by irradiating one point of a ranging region with light while shifting an irradiation position in the ranging region. The sequential flash method is a method of repeatedly performing a process of ranging by irradiating a part of a ranging region with light while shifting an irradiation area within the ranging region. The flash method is a method of performing ranging by irradiating the entire ranging region with light collectively and receiving reflected light by a pixel array.

The light received by the light receiving device 4 includes ambient light such as sunlight in addition to reflected light from the object 2. Therefore, the ranging device 1 performs ranging in which the influence of ambient light is reduced by using a method of measuring the light incident in each of a plurality of periods (bin periods) and determining that the reflected light is incident in a period in which the amount of light is a peak.

The light emitting device 3 is a device such as a semiconductor laser that emits light such as laser light to the outside of the ranging device 1. When the ranging device 1 operates in the scan method, the light emitting device 3 may be a point light source. When the ranging device 1 operates in the sequential flash method, the light emitting device 3 may be a line light source or a pattern light source. When the ranging device 1 operates in the flash method, the light emitting device 3 may be a surface light source.

The signal processing circuit 5 may include a control circuit, a counter circuit, a processor that performs arithmetic processing of a digital signal, a memory that stores a digital signal, and the like. The memory may be, for example, a semiconductor memory.

The light receiving device 4 generates a pulse signal including a pulse based on the incident light, counts the pulses, and generates a light reception count value. The light receiving device 4 is, for example, a photoelectric conversion device including an avalanche photodiode as a photoelectric conversion element. In this case, when one photon enters the avalanche photodiode and a charge is generated, one pulse is generated by avalanche multiplication. However, the light receiving device 4 may be, for example, a photoelectric conversion element using another photodiode.

In the sequential flash method and the flash method, reflected light is simultaneously detected by a plurality of pixels. In the scan method, the reflected light may be simultaneously detected by a plurality of pixels in order to improve accuracy. The light receiving device 4 of the present embodiment includes a plurality of pixels in order to apply these methods.

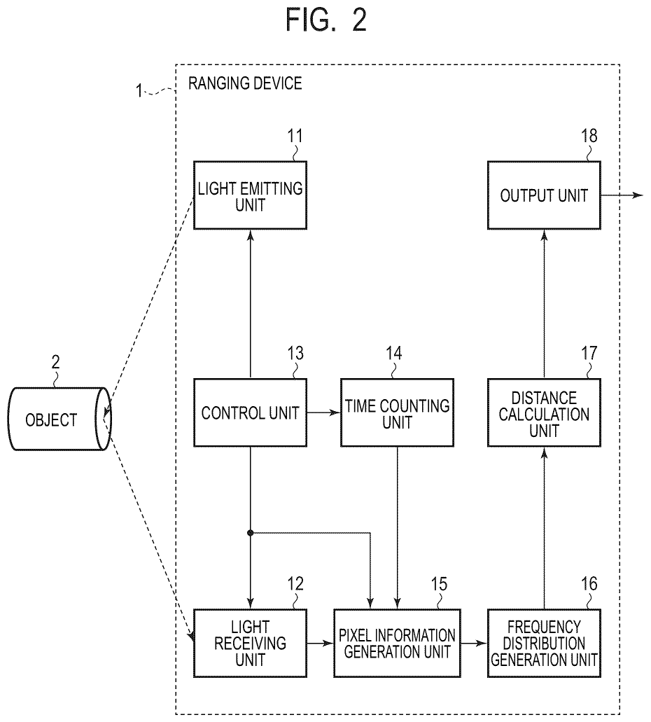

FIG. 2 is a functional block diagram illustrating a schematic configuration example of the ranging device 1 according to the present embodiment. The ranging device 1 includes a light emitting unit 11, a light receiving unit 12, a control unit 13, a time counting unit 14, a pixel information generation unit 15, a frequency distribution generation unit 16, a distance calculation unit 17, and an output unit 18. The light emitting unit 11 and the light receiving unit 12 correspond to the light emitting device 3 and the light receiving device 4 in FIG. 1, respectively. The control unit 13, the time counting unit 14, the pixel information generation unit 15, the frequency distribution generation unit 16, the distance calculation unit 17, and the output unit 18 correspond to the signal processing circuit 5 in FIG. 1.

The control unit 13 controls the light emission timing of the light emitting unit 11. The control unit 13 has a function of outputting a clock signal to the light receiving unit 12, the time counting unit 14, and the pixel information generation unit 15.

The time counting unit 14 performs time counting under the control of the control unit 13 to generate an elapsed time from the time when the time counting is started as a time count value, and outputs the time count value to the pixel information generation unit 15. The control unit 13 synchronously controls the light emission timing and the start timing of the time counting in the time counting unit 14. Accordingly, the time counting unit 14 can count the elapsed time from the light emission in the light emitting unit 11. The time counting unit 14 includes, for example, a circuit such as a ring oscillator and a counter, and performs the time counting by counting clock signals that oscillate at high speed and in a constant cycle.

In addition, the control unit 13 performs overall control of signal acquisition in one frame period in the ranging device 1. Accordingly, the ranging device 1 is controlled to perform the light emission in the light emitting unit 11 and start the time counting in the time counting unit 14 a plurality of times in one frame period.

The light emitted from the light emitting unit 11 is reflected by the object 2. The light including the reflected light from the object 2 is received by the light receiving unit 12. The light receiving unit 12 converts the received light into pulses of an electrical signal by photoelectric conversion. The pulses are counted in the light receiving unit 12, and a light reception count value is generated.

The pixel information generation unit 15 acquires the light reception count value generated by the light receiving unit 12 and the time count value output from the time counting unit 14. The pixel information generation unit 15 outputs pixel information in which the light reception count value and the time count value are associated with each other for each pixel.

The generated pixel information is accumulated in the form of a frequency distribution in the frequency distribution generation unit 16. The frequency distribution is information in which a class that is set at a predetermined time interval and a frequency of a light reception count value based on incident light within a period corresponding to each class are associated with each other. The frequency distribution generation unit 16 includes a memory that stores a frequency distribution for each pixel. When the frequency distribution for one ranging frame is accumulated in the frequency distribution generation unit 16, the distance calculation unit 17 calculates, from the frequency distribution of each pixel, distance information of the corresponding pixel. The output unit 18 outputs the calculated distance information to the outside.

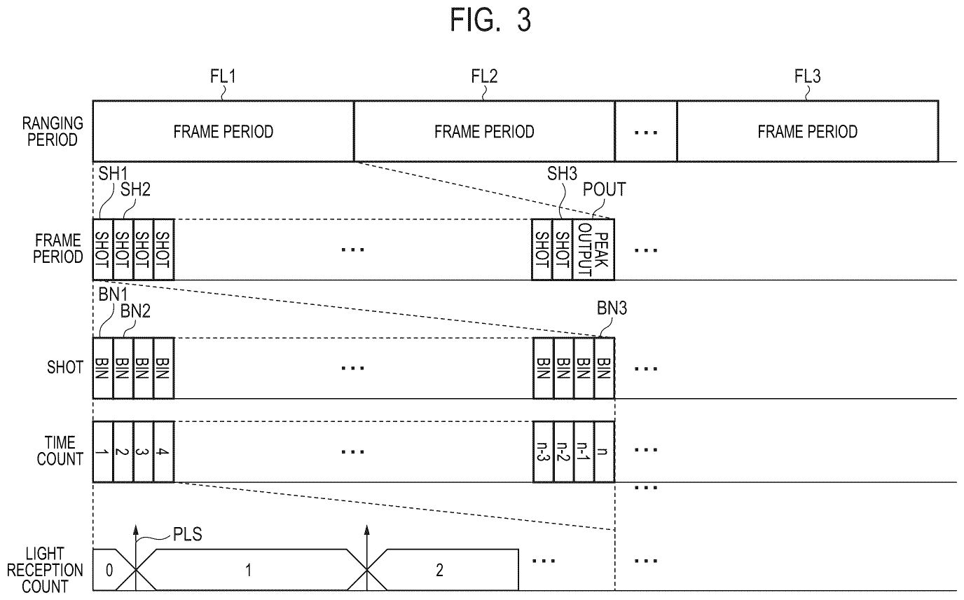

FIG. 3 is a diagram schematically illustrating an operation of the ranging device 1 in one distance measuring period according to the present embodiment. In the “ranging period” of FIG. 3, a plurality of frame periods FL1, FL2, . . . FL3 included in one ranging period is illustrated. A frame period FL1 indicates a first frame period in one ranging period, a frame period FL2 indicates a second frame period in one ranging period, and a frame period FL3 indicates the last frame period in one ranging period. The frame period is a period in which the ranging device 1 performs ranging once and outputs a signal indicating a distance (ranging result) from the ranging device 1 to the object 2 to the outside once.

In the “frame period” of FIG. 3, a plurality of shots SH1, SH2, . . . SH3 and a peak output POUT included in the frame period FL1 are illustrated. The shot is one period in which the light emitting unit 11 performs light emission and the frequency distribution is updated by the light reception pulse PLS based on the light emission. A shot SH1 indicates a first shot in the frame period FL1. A shot SH2 indicates a second shot in the frame period FL1. The shot SH3 indicates the last shot in the frame period FL1. The peak output POUT indicates a period in which a ranging result is output based on a peak obtained by accumulating signals of the plurality of shots.

In the “shot” in FIG. 3, a plurality of bins BN1, BN2, . . . BN3 included in the shot SH1 is illustrated. The “bin” indicates one time interval (bin period) at which a series of pulse counting is performed. The bin BN1 indicates a first bin in the shot SH1. The bin BN2 indicates a second bin in the shot SH1. The bin BN3 indicates the last bin in the shot SH1.

The “time count” in FIG. 3 schematically illustrates a temporal change of the time count value generated in the time counting unit 14. As illustrated in FIG. 3, the time counting unit 14 increments the count value for each time interval of the bin according to the elapse of time. Therefore, the time count value is a parameter indicating the bin number.

The “light reception count” in FIG. 3 schematically illustrates, in the bin BN1, the light reception pulse PLS based on the incident light and the change in the light reception count value of the bin BN1. As illustrated in FIG. 3, when the light reception pulse PLS rises, the light reception count value is incremented by one. As a result, the number of photons detected in the bin period is acquired as the light reception count value. When one bin period elapses and the process transitions to the next bin period, the light reception count value is reset to zero.

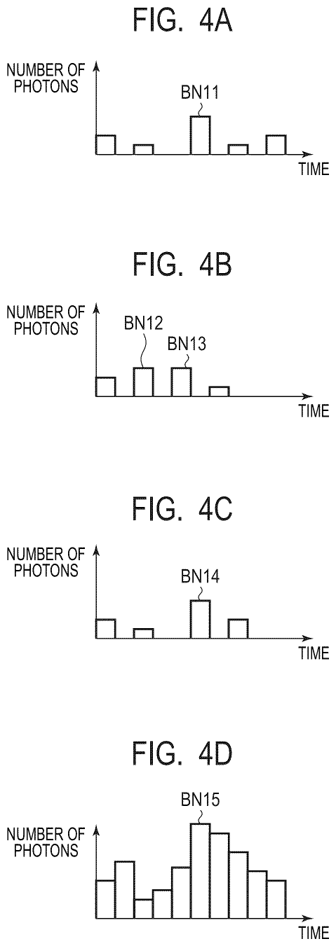

FIGS. 4A to 4D are histograms visually illustrating frequency distributions generated by the frequency distribution generation unit 16. In the present specification, the frequency distribution is frequency information corresponding to a predetermined class width, and is not necessarily displayed visually. FIGS. 4A, 4B, and 4C are examples of histograms of the numbers of photons (corresponding to the light reception count values) in the first shot, the second shot, and the third shot, respectively. FIG. 4D is an example of a histogram in which the numbers of photons of all shots are accumulated. The horizontal axis indicates the elapsed time from light emission. One interval of the histogram corresponds to the period of one bin in which photon detection occurs. The vertical axis indicates the number of photons detected in each bin period.

As illustrated in FIG. 4A, in the first shot, photons are incident in five bin periods. As illustrated in FIG. 4B, in the second shot, photons are incident in four bin periods. As illustrated in FIG. 4C, also in the third shot, photons are incident in four bin periods. As described above, the number of incident photons and the incident time are different in each shot. These frequency distributions may include the frequency due to not only the light reception count value of the reflected light from the object 2 but also the light reception count value of the ambient light other than the reflected light.

As illustrated in FIG. 4D, since the number of photons in the sixth bin BN15 is the maximum in the histogram in which the numbers of photons in all shots are accumulated, the bin BN15 is a peak. In the peak output POUT of FIG. 3, the time information of the bin corresponding to the peak of the frequency distribution after accumulation is output. This time information indicates the flight time of the light emitted from the light emitting unit 11 and reflected by the object 2, and can be used to calculate the distance between the ranging device 1 and the object 2.

By accumulating the pulse count values of the plurality of shots, it is possible to detect a bin that is more likely to include a pulse count value due to reflected light from the object 2 with higher accuracy even when a pulse count value due to ambient light may be included. Therefore, even when the light emitted from the light emitting unit 11 is weak, the ranging can be performed with high accuracy by adopting a process of repeating a plurality of shots and accumulating the count values.

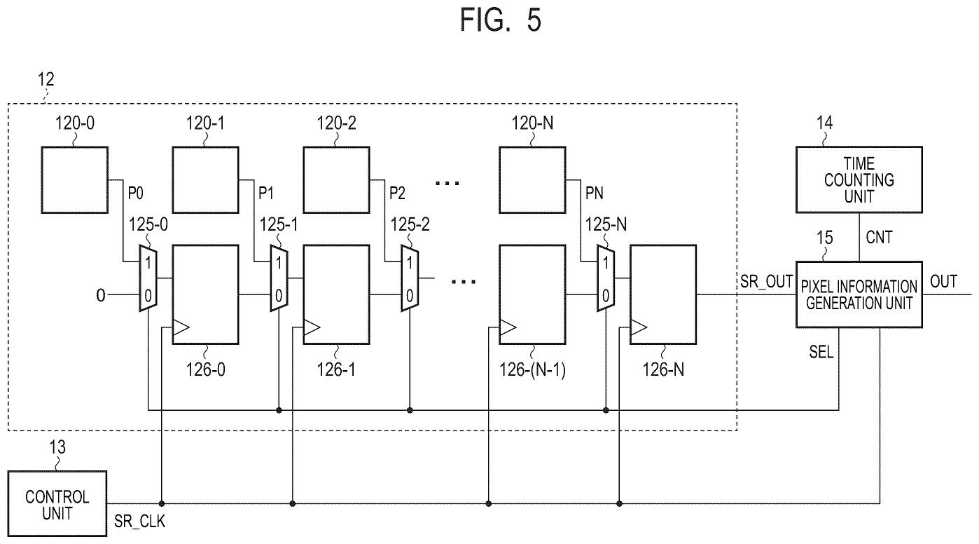

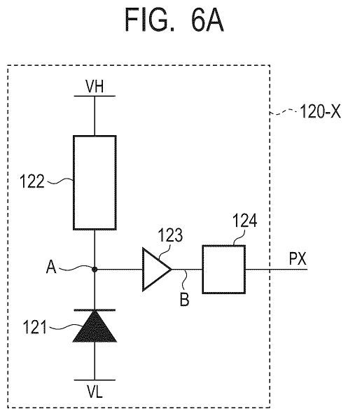

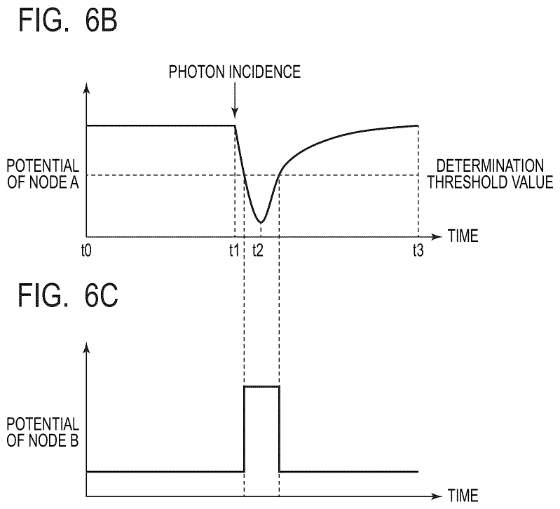

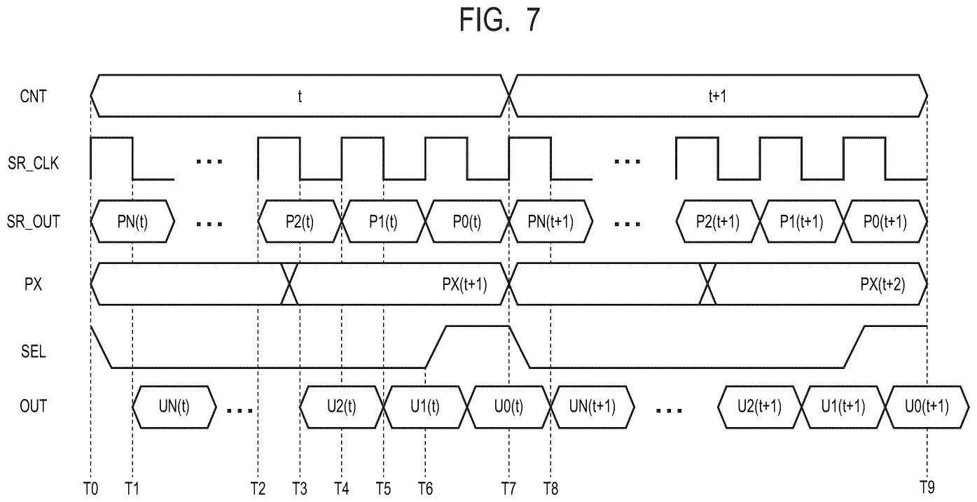

Next, a method of acquiring the light reception count value from the light receiving unit 12 will be described with reference to FIGS. 5 to 7. FIG. 5 is a diagram illustrating a configuration of the light receiving unit 12, the control unit 13, the time counting unit 14, and the pixel information generation unit 15 according to the present embodiment. FIGS. 6A to 6C are diagrams illustrating a configuration and an operation of the pixel 120 according to the present embodiment. FIG. 7 is a timing chart illustrating an operation of the ranging device 1 according to the present embodiment.

As illustrated in FIG. 5, the light receiving unit 12 includes a plurality of pixels 120, a plurality of selectors 125, and a plurality of registers 126. The plurality of selectors 125 and the plurality of registers 126 are arranged so as to correspond to the plurality of pixels 120, respectively. It is assumed that each of the number of the plurality of pixels 120, the number of the plurality of selectors 125, and the number of the plurality of registers 126 are N+1. Further, in FIG. 5, for example, the pixels 120-0, 120-1, 120-2, . . . 120-N are distinguished from each other by attaching a branch number to the end of the reference numerals of the N+1 pixels 120. In the following description, when it is necessary to distinguish a plurality of elements from each other, the reference numerals may be denoted with branch numbers.

The configuration and operation of one of the plurality of pixels 120 will be described with reference to FIGS. 6A to 6C. As illustrated in FIG. 6A, a pixel 120-X (X is an integer of 0 or more and N or less) includes an avalanche photodiode (APD) 121, a quenching element 122, a waveform shaping unit 123, and a counter circuit 124. Although only the pixel 120-X is extracted and illustrated in FIG. 6A, the other pixels 120 also have the same configuration.

The APD 121 is a photoelectric conversion element that generates a charge according to incident light by photoelectric conversion. A voltage VL (first voltage) is supplied to an anode of the APD 121. A cathode of the APD 121 is connected to a first terminal of the quenching element 122 and an input terminal of the waveform shaping unit 123. A voltage VH (second voltage) higher than the voltage VL supplied to the anode of the APD 121 is supplied to a second terminal of the quenching element 122. Thus, the anode and the cathode of the APD 121 are supplied with a reverse bias voltage that causes the APD 121 to perform an avalanche multiplication operation. In the APD 121 to which the reverse bias voltage is supplied, when a charge is generated by incident light, the charge causes avalanche multiplication, and an avalanche current is generated.

Note that operation modes when the reverse bias voltage is supplied to the APD 121 includes a Geiger mode and a linear mode. The Geiger mode is a mode of operating with a potential difference between the anode and the cathode being larger than the breakdown voltage, and the linear mode is a mode of operating with the potential difference between the anode and the cathode being close to or smaller than the breakdown voltage.

An APD operated in Geiger mode is referred to as a single photon avalanche diode (SPAD). At this time, for example, the voltage VL (first voltage) is −30 V, and the voltage VH (second voltage) is 1 V. The APD 121 may be operated in the linear mode or the Geiger mode. In the case of the SPAD, since the potential difference becomes large and the effect of avalanche multiplication becomes remarkable as compared with the APD of the linear mode, the SPAD is preferable.

The quenching element 122 functions as a load circuit (quenching circuit) at the time of signal multiplication by avalanche multiplication. The quenching element 122 suppresses the avalanche multiplication by suppressing the voltage supplied to the APD 121 (quenching operation). In addition, the quenching element 122 returns the voltage supplied to the APD 121 to the voltage VH by flowing a current corresponding to the voltage drop due to the quenching operation (recharge operation). The quenching element 122 may be, for example, a resistive element or a transistor.

The waveform shaping unit 123 shapes the potential change of the cathode of the APD 121 obtained at the time of photon detection and outputs a pulse signal. As the waveform shaping unit 123, for example, an inverter circuit is used. FIG. 6A illustrates an example in which one inverter is used as the waveform shaping unit 123, but the waveform shaping unit 123 may be a circuit in which a plurality of inverters is connected in series, or may be another circuit having a waveform shaping effect.

The counter circuit 124 counts the pulse signal output from the waveform shaping unit 123 and holds the digital signal. The counter circuit 124 has a function of resetting a signal held when a control signal is supplied from a control circuit such as the control unit 13. The pixel 120-X can output the digital signal held in the counter circuit 124 as the light reception count value PX (any of P0, P1, . . . PN).

As illustrated in FIG. 6A, a connection node of input terminals of the APD 121, the quenching element 122, and the waveform shaping unit 123 is referred to as a node A. As illustrated in FIG. 6A, a connection node between an output terminal of the waveform shaping unit 123 and the counter circuit 124 is referred to as a node B.

FIG. 6B is a graph illustrating a temporal change in the potential of the node A in FIG. 6A. FIG. 6C is a graph illustrating a temporal change in the potential of the node B in FIG. 6A. In a period from time t0 to time t1, a voltage of VH-VL is applied to the APD 121 in FIG. 6A. When a photon enters the APD 121 at the time t1, avalanche multiplication occurs in the APD 121. As a result, an avalanche current flows through the quenching element 122, and the potential of the node A falls. Thereafter, the amount of potential drop further increases, and the voltage applied to the APD 121 gradually decreases. Then, at time t2, the avalanche multiplication in the APD 121 is stopped. Thus, the voltage level of the node A does not drop below a certain value. After that, in a period from the time t2 to time t3, a current that compensates for the voltage drop from the node of the voltage VH flows in the node A, and the node A is settled to the original potential at the time t3.

In the above process, the potential of the node B becomes the high level in a period in which the potential of the node A is lower than a certain threshold. In this manner, the waveform of the drop in the potential of the node A caused by the incidence of the photon is shaped by the waveform shaping unit 123 and output as a pulse to the node B. The counter circuit 124 counts the pulses to generate a light reception count value PX. As described above, the ranging device 1 of the present embodiment may include the pixel 120-X using the avalanche photodiode as the photoelectric conversion element.

Referring back to FIG. 5, the configuration of other elements of the light receiving unit 12 will be described. Each of the selectors 125-0, 125-1, 125-2, . . . 125-N has a first input terminal, a second input terminal, an output terminal, and a control terminal. A signal SEL is input to the control terminals of the selectors 125-0, 125-1, 125-2, . . . 125-N from the pixel information generation unit 15. When the signal SEL is at the high level (signal value “1”), each of the selectors 125-0, 125-1, 125-2, . . . 125-N outputs a signal at the same level as the signal input to the first input terminal. When the signal SEL is at the low level (signal value “0”), each of the plurality of selectors 125-0, 125-1, 125-2, . . . 125-N outputs a signal at the same level as the signal input to the second input terminal.

Output terminals of the pixels 120-0, 120-1, 120-2, . . . 120-N are connected to first input terminals of selectors 125-0, 125-1, 125-2, . . . 125-N, respectively. That is, the pixels 120-0, 120-1, 120-2, . . . 120-N output the light reception count values P0, P1, P2, . . . PN to the first input terminals of the selectors 125-0, 125-1, 125-2, . . . 125-N, respectively.

Each of the registers 126-0, 126-1, 126-2, . . . 126-N has an input terminal, an output terminal, and a control terminal. Each of the registers 126-0, 126-1, 126-2, . . . 126-N is a sequential circuit having a function of holding an input signal and may include a flip-flop circuit.

A low-level signal is input to the second input terminal of the selector 125-0. The output terminal of the selector 125-0 is connected to the input terminal of the register 126-0. The output terminal of the register 126-0 is connected to the second input terminal of the selector 125-1. The output terminal of the selector 125-1 is connected to the input terminal of the register 126-1. The output terminal of the register 126-1 is connected to the second input terminal of the selector 125-2. Similarly, the selector 125 and the register 126 are alternately connected. The output terminal of the register 126-N is connected to the pixel information generation unit 15. An output signal of the register 126-N is referred to as a signal SR_OUT.

The control unit 13 outputs a clock signal SR_CLK to the control terminals of the registers 126-0, 126-1, 126-2, . . . 126-N and the pixel information generation unit 15. The registers 126-0, 126-1, 126-2, . . . 126-N constitute a shift register. When the signal SEL is at the low level (second state), each of the registers 126-0, 126-1, 126-2, . . . 126-N holds a signal input to the input terminal at a timing when the clock signal SR_CLK rises, and continues to output the signal from the output terminal. Thus, every time the clock signal SR_CLK rises, the signal held in the register 126 of each stage is shifted to the register 126 of the next stage.

When the signal SEL is at the high level (first state), the registers 126-0, 126-1, 126-2, . . . 126-N are connected to the pixels 120-0, 120-1, 120-2, . . . 120-N, respectively. In this case, the registers 126-0, 126-1, 126-2, . . . 126-N acquire and hold the light reception count values P0, P1, P2, . . . PN from the pixels 120-0, 120-1, 120-2, . . . 120-N, respectively.

The time counting unit 14 outputs a time count value CNT to the pixel information generation unit 15. The pixel information generation unit 15 associates the signal SR_OUT output from the register 126-N with the time count value CNT at the time when the signal SR_OUT is input, and outputs them to the frequency distribution generation unit 16 as the pixel information OUT.

FIG. 7 is a timing chart illustrating an operation of the ranging device according to the present embodiment. FIG. 7 illustrates temporal changes of the time count value CNT, the clock signal SR_CLK, the signal SR_OUT, the light reception count value PX, the signal SEL, and the pixel information OUT illustrated in FIG. 5 or FIG. 6A.

The time count value CNT is a value of a signal output from the time counting unit 14 to the pixel information generation unit 15, and corresponds to a bin number. FIG. 7 illustrates a period in which the value of the time count value CNT is t and a period in which the value of the time count value CNT is (t+1).

The clock signal SR_CLK indicates a signal input from the control unit 13 to the registers 126-0, 126-1, 126-2, . . . 126-N. The clock signal SR_CLK is also input to the pixel information generation unit 15, and is used for synchronization of timing of signal acquisition and the like.

The signal SR_OUT is an output signal from the register 126-N that is the last stage of the shift register, and is input to the pixel information generation unit 15. FIG. 7 illustrates the value of the signal SR_OUT and changes thereof. In FIG. 7, the “P0(t)” indicates the light reception count value output from the 0th pixel 120-0 in the period in which the value of the time count value CNT is t. The “PN(t)” indicates the light reception count value output from the N-th pixel 120-N in the period in which the value of the time count value CNT is t. The “P0(t+1)” indicates the light reception count value output from the 0th pixel 120-0 in the period in which the value of the time count value CNT is (t+1). The “PN(t+1)” indicates the light reception count value output from the N-th pixel 120-N in the period in which the value of the time count value CNT is (t+1). Notations of other values of the signal SR_OUT are similarly defined.

The light reception count value PX is a signal output from the X-th pixel 120-X. The “PX (t+1)” in FIG. 7 indicates the light reception count value corresponding to the period in which the value of the time count value CNT is (t+1) among the light reception count values repeatedly output from the pixel 120-X.

The signal SEL is a switching signal input from the pixel information generation unit 15 to the selectors 125-0, 125-1, 125-2, . . . 125-N. When the signal SEL is at the low level (signal value “0”), the output signal of the register 126 in the previous stage is input to each selector 125. When the signal SEL is at the high level (signal value “1”), the light reception count value output from the corresponding pixel 120 is input to each selector 125.

The pixel information OUT is an output signal that is output from the pixel information generation unit 15 to the frequency distribution generation unit 16. The pixel information OUT includes the light reception count value of each pixel and the time count value associated with the light reception count value. In FIG. 7, the “U0(t)” indicates pixel information including the light reception count value from the 0th pixel 120-0 in the period in which the value of the time count value CNT is t. The “UN(t)” indicates pixel information including the light reception count value from the N-th pixel 120-N in the period in which the value of the time count value CNT is t. The “U0(t+1)” indicates pixel information including the light reception count value from the 0th pixel 120-0 in the period in which the value of the time count value CNT is (t+1). The “UN(t+1)” indicates pixel information including the light reception count value from the N-th pixel 120-N in the period in which the value of the time count value CNT is (t+1). Notations of other values of the pixel information OUT are similarly defined.

Next, a temporal change of each signal will be described with reference to FIG. 7. At time T0, the clock signal SR_CLK transitions (rises) from the low level to the high level. At this time, the value of the time count value CNT is incremented from (t-1) to t. The time count value CNT is incremented by one every time the number of times the clock signal SR_CLK rises reaches a predetermined number. In the present embodiment, the predetermined number, that is, the number of pulses of the clock signal SR_CLK per one count of the time count value CNT is equal to the number (N+1) of the pixels 120, but the predetermined number is not limited thereto.

When the rising edge of the clock signal SR_CLK is input to each register 126 while the signal SEL is at the high level, each register 126 holds the light reception count value output from the corresponding pixel 120. Therefore, at the timing of the time TO, each register 126 holds the light reception count value output from the corresponding pixel 120. At this time, the signal SR_OUT, which is the output signal of the N-th register 126-N, is the light reception count value (PN(t)) output from the N-th pixel 120-N.

After the time T0, the signal SEL starts transition from the high level to the low level. When the rising edge of the clock signal SR_CLK is input to each register 126 while the signal SEL is at the low level, each register 126 holds an output signal of the register 126 in the previous stage. Therefore, after the time TO, every time the rising edge of the clock signal SR_CLK is input to the register 126, the shift register performs an operation of shifting the held signals one stage at a time. That is, at the timing when the value of the time count value CNT is incremented from (t-1) to t, the holding of the light reception count value in the shift register is completed, and switching to a state in which the shift register can perform the operation of shifting the light reception count value is performed.

At time T1, the clock signal SR_CLK transitions (falls) from the high level to the low level. The pixel information generation unit 15 sequentially acquires the value of the signal SR_OUT every time the falling edge of the clock signal SR_CLK is input, and generates and outputs the pixel information OUT. At the time T1, the pixel information generation unit 15 acquires PN(t) as the signal SR_OUT and outputs UN(t) as the pixel information OUT.

After the time T1, the shift of the signal held in the shift register and the reading of the signal to the pixel information generation unit 15 are sequentially repeated in accordance with the transition of the clock signal SR_CLK. For example, at time T2, the clock signal SR_CLK rises, and the signal SR_OUT, which is the output signal of the N-th register 126-N, becomes the light reception count value (P2(t)) output from the second pixel 120-2. Thereafter, at time T3, the clock signal SR_CLK falls, and the pixel information generation unit 15 acquires P2(t) as the signal SR_OUT and outputs U2(t) as the pixel information OUT. As another example, at time T4, the clock signal SR_CLK rises, and the signal SR_OUT, which is the output signal of the N-th register 126-N, becomes the light reception count value (P1(t)) output from the first pixel 120-1. Thereafter, at time T5, the clock signal SR_CLK falls, and the pixel information generation unit 15 acquires P1(t) as the signal SR_OUT and outputs U1(t) as the pixel information OUT.

After time T6, the signal SEL starts transition from the low level to the high level. Thereafter, when the rising edge of the clock signal SR_CLK is input to each register 126 at time T7, the registers 126 hold the light reception count values (PN(t+1), . . . . P2 (t+1), P1(t+1), P0(t+1)) output from the corresponding pixels 120. At the time T7, the value of the time count value CNT is incremented from t to (t+1) in response to the rising edge of the clock signal SR_CLK. Therefore, a period from the time T0 to the time T7 is a period in which the time count value CNT is one value (t) (that is, a period required for the time count value to change by one), and this period corresponds to one bin period in the generation of the frequency distribution. This period includes a plurality of cycles of the clock signal SR_CLK, and the clock signal SR_CLK rises a plurality of times. In other words, the period of the pulses of the clock signal SR_CLK is shorter than the period in which the time count value CNT changes. Therefore, the pixel information generation unit 15 can read the light reception count values PX from the plurality of pixels 120 in a period in which the time count value CNT is one value t.

Also in a period from the time T7 to time T9, the same processing as in the period from the time T0 to the time T7 is performed except that the time count value is changed from t to (t+1). In addition, also in a period before the time T0 and a period after the time T9, the same processing as the period from the time T0 to the time T7 is repeatedly performed except that the time count value is different.

As described above, the period required until the time count value changes by one from t to (t+1) is the period from the time T0 to the time T7. The period in which the pixel information generation unit 15 acquires the light reception count value of each of the plurality of pixels 120 and outputs the pixel information OUT is a period from the time T1 to the time T8. Here, the time during which the time count value changes by one is equal to a length of the period in which the pixel information generation unit 15 acquires the light reception count value of each of the plurality of pixels 120 and outputs the pixel information OUT of each of the plurality of pixels 120. Accordingly, it is possible to reduce the loss of the information of the incident light due to the change in the value of the time count value CNT during the readout of the plurality of pixels 120. The same effect can be obtained as long as the length of the period in which the pixel information generation unit 15 acquires the light reception count value of each of the plurality of pixels 120 and outputs the pixel information OUT of each of the plurality of pixels 120 is equal to or less than the time in which the time count value changes by one.

In the present embodiment, the pixel information generation unit 15 outputs the pixel information OUT of each of the plurality of pixels 120 in a period of the same length as the time when the time count value changes by one. However, the time count value may be a predetermined value greater than one, although the effects described above may vary. That is, the pixel information generation unit 15 may be configured to acquire the light reception count value of each of the plurality of pixels 120 and output the pixel information OUT of each of the plurality of pixels 120 within a period of time equal to or less than the time in which the time count value changes by a predetermined value.

As described above, according to the present embodiment, the ranging device 1 capable of reducing loss of information of incident light is provided.

FIG. 7 illustrates an example in which the pixel information generation unit 15 acquires the value of the signal SR_OUT in response to the falling edge of the clock signal SR_CLK and generates and outputs the pixel information OUT, but the pixel information generation unit 15 is not limited thereto. For example, the pixel information generation unit 15 may acquire the value of the signal SR_OUT in response to the rising edge of the clock signal SR_CLK and generate and output the pixel information OUT.

Although FIG. 5 illustrates a configuration in which the plurality of pixels 120 is arranged so as to form one row and a plurality of columns and the pixel information generation unit 15 is arranged so as to correspond to the one row, the plurality of pixels 120 may be arranged so as to form a plurality of rows and a plurality of columns. In this case, the pixel information generation unit 15 may process the output signals of the plurality of pixels 120 for a row basis or may collectively process the output signals of a plurality of rows.

### Second Embodiment

In the first embodiment, the pixel information generation unit 15 sequentially outputs the pixel information OUT of the plurality of pixels 120 in accordance with the clock signal SR_CLK. In the present embodiment, a configuration example in which the pixel information generation unit 15 can output the pixel information OUT of the plurality of pixels 120 in parallel will be described. Description of elements common to those of the first embodiment may be omitted or simplified as appropriate.

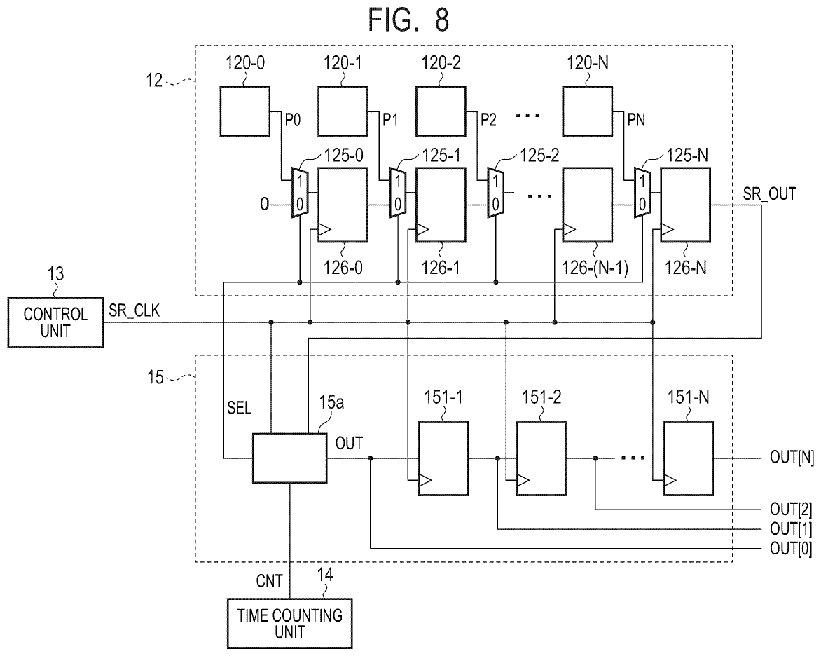

FIG. 8 is a diagram illustrating a configuration of the light receiving unit 12, the control unit 13, the time counting unit 14, and the pixel information generation unit 15 according to the present embodiment. The configurations of the light receiving unit 12, the control unit 13, and the time counting unit 14 are the same as those in FIG. 5. The pixel information generation unit 15 includes a generation processing unit 15a and a plurality of registers 151. It is assumed that the number of the plurality of registers 151 is N, and the registers 151-1, 151-2, . . . 125-N are illustrated with branch numbers in FIG. 8.

The generation processing unit 15a is a circuit that performs the same operation as that of the pixel information generation unit 15 in the first embodiment. The generation processing unit 15a receives the time count value CNT from the time counting unit 14, the signal SR_OUT from the register 126-N, and the clock signal SR_CLK from the control unit 13. The generation processing unit 15a sequentially outputs the pixel information OUT of each pixel 120.

Each of the registers 151-1, 151-2, . . . 151-N has an input terminal, an output terminal, and a control terminal. Each of the registers 151-1, 151-2, . . . 151-N has a function of holding an input signal and may include a flip-flop circuit. The control unit 13 outputs the clock signal SR_CLK to the control terminals of the registers 151 in addition to the registers 126 and the pixel information generation unit 15.

The pixel information OUT output from the generation processing unit 15a is input to the input terminal of the register 151-1. The output terminal of the register 151-1 is connected to the input terminal of the register 151-2. Similarly, the registers 151-1, 151-2, . . . 151-N are cascaded to form a shift register. Each of the registers 151-1, 151-2, . . . 151-N holds a signal input to the input terminal at a timing when the clock signal SR_CLK falls, and continues to output the signal from the output terminal. Thus, every time the clock signal SR_CLK falls, the signal held in the register 151 of each stage is shifted to the register 151 of the next stage.

A node of the output terminal of the generation processing unit 15a and a node of the output terminal of the registers 151-1, 151-2, . . . 151-N are connected to a plurality of output terminals of the pixel information generation unit 15. A signal output from the node of the output terminal of the generation processing unit 15a is referred to as pixel information OUT[0]. Signals output from the nodes of the output terminals of the registers 151-1, 151-2, . . . 151-N are referred to as pixel information OUT[1], OUT[2], . . . OUT[N], respectively. The pixel information OUT[0] is the same as the pixel information OUT. The plurality of output terminals of the pixel information generation unit 15 is connected to the frequency distribution generation unit 16. That is, in the present embodiment, the pixel information generation unit 15 outputs the pixel information OUT[0], OUT[1], OUT[2], . . . OUT[N] to the frequency distribution generation unit 16 in parallel.

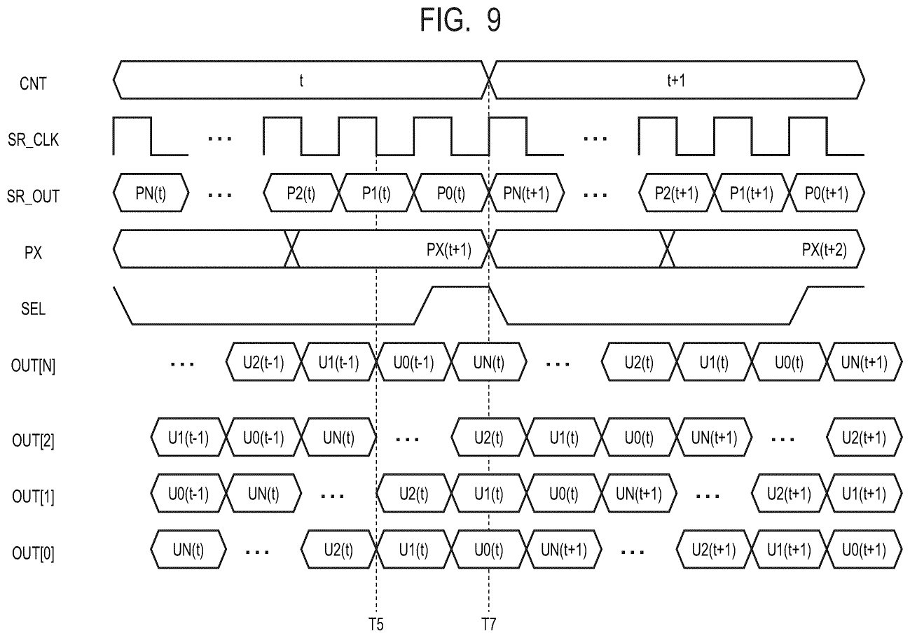

FIG. 9 is a timing chart illustrating an operation of the ranging device according to the present embodiment. FIG. 9 illustrates temporal changes of the time count value CNT, the clock signal SR_CLK, the signal SR_OUT, the light reception count value PX, the signal SEL, and the pixel information OUT[0], OUT[1], OUT[2], . . . . OUT[N] illustrated in FIG. 8 or FIG. 6A. The temporal changes of the time count value CNT, the clock signal SR_CLK, the signal SR_OUT, the light reception count value PX, and the signal SEL are the same as those in FIG. 7. The temporal change of the pixel information OUT[0] is the same as that of the pixel information OUT in FIG. 7.

Since the registers 151-1, 151-2, . . . 151-N constitute a shift register, as illustrated in FIG. 9, each register 151 holds the output signal of the register 151 of the previous stage every time the clock signal SR_CLK falls. Therefore, every time the falling edge of the clock signal SR_CLK is input to the register 151, the shift register performs an operation of shifting the held signal one stage at a time. For example, when the clock signal SR_CLK falls at the time T5, U2(t) that is output from the generation processing unit 15a as the 0th pixel information OUT[0] in the period before the time T5 is held in the first register 151-1. Accordingly, in a period after the time T5, the first register 151-1 outputs U2(t) as the first pixel information OUT[1].

In this way, the signals in the registers 151-1, 151-2, . . . 151-N are shifted. Thereafter, at the time T7, the pixel information OUT[0], OUT[1], OUT[2], . . . OUT[N] become U0(t), U1(t), U2(t), . . . UN(t), respectively, and the pixel information corresponding to each pixel 120 is output in parallel. As described above, the shift register configured by the registers 151-1, 151-2, . . . 151-N functions as a serial-to-parallel conversion circuit that performs serial-to-parallel conversion on the pixel information OUT output from the generation processing unit 15a. Accordingly, the pixel information generation unit 15 can output the pixel information OUT[0], OUT[1], OUT[2], . . . OUT[N] to the frequency distribution generation unit 16 in parallel.

In the configuration in which the pixel information OUT of each pixel 120 is sequentially output as in the first embodiment, the pixel information OUT is input to the frequency distribution generation unit 16 at the same cycle as the clock signal SR_CLK. On the other hand, the pixel information OUT[0], OUT[1], OUT[2], . . . . OUT[N] of each pixel 120 is input to the frequency distribution generation unit 16 of the present embodiment in parallel at the same cycle as the increment cycle of the time count value CNT. Therefore, the processing cycle of the frequency distribution generation unit 16 can be lengthened, and the processing load is reduced.

According to the present embodiment, as in the first embodiment, the ranging device 1 capable of reducing loss of information of incident light is provided. In addition, in the present embodiment, the processing cycle of the frequency distribution generation unit 16 can be lengthened, and the processing load can be reduced.

### Third Embodiment

Although FIG. 5 of the first embodiment exemplarily illustrates a configuration in which the plurality of pixels 120 is arranged in one row in the light receiving unit 12, the plurality of pixels 120 may be arranged so as to form a plurality of rows and a plurality of columns. In the present embodiment, a configuration example in which a plurality of pixels 120 is arranged to form a plurality of rows and a plurality of columns will be described. Description of elements common to the first embodiment or the second embodiment may be omitted or simplified as appropriate.

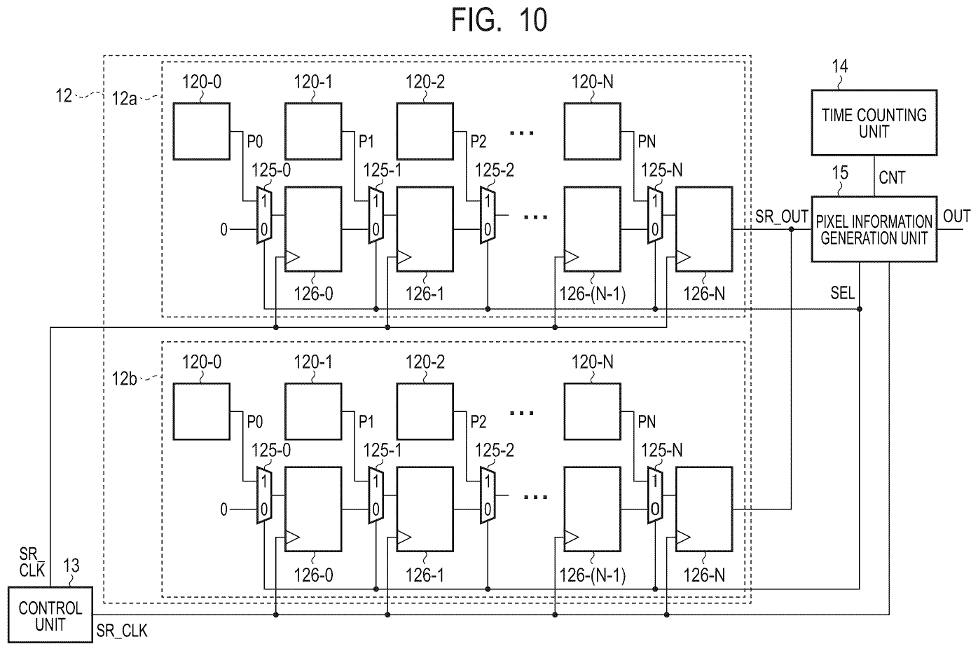

FIG. 10 is a diagram illustrating a configuration of the light receiving unit 12, the control unit 13, the time counting unit 14, and the pixel information generation unit 15 according to the present embodiment. The light receiving unit 12 includes a pixel block 12a and a pixel block 12b. Each of the pixel block 12a and the pixel block 12b includes the same element as the light receiving unit 12 of the first embodiment. The light receiving unit 12 includes pixels 120 arranged in a plurality of rows and a plurality of columns. The pixel block 12a includes pixels 120 in a first row of the plurality of rows. The pixel block 12b includes pixels 120 in a second row of the plurality of rows. The plurality of selectors 125 and the plurality of registers 126 are arranged so as to respectively correspond to the plurality of pixels 120, as in the first embodiment. The control unit 13 outputs the clock signal SR_CLK to the registers 126 of the pixel block 12a, the registers 126 of the pixel block 12b, and the pixel information generation unit 15.

The output terminal of the register 126-N of the pixel block 12a and the output terminal of the register 126-N of the pixel block 12b are both connected to the common pixel information generation unit 15. That is, the light reception count values from the pixels 120 in the two rows are input to the common pixel information generation unit 15. Therefore, the time counting unit 14 and the pixel information generation unit 15 are shared by two rows.

The pixel information generation unit 15 may sequentially process the light reception count values of two rows one by one, or may process the light reception count values of two rows in parallel. For example, when the ranging device 1 performs ranging by the flash method, signals may be simultaneously output from the registers 126-N of a plurality of rows. Even in such a case, the pixel information generation unit 15 sequentially processes the light reception count values of two rows one by one or processes the light reception count values of two rows in parallel, so that the loss of pixel information can be avoided. Alternatively, the pixel information generation unit 15 may assign identification information to the pixel information and then output the pixel information of the pixels 120 in any one row.

In addition, the pixel information generation unit 15 may calculate the logical sum of the output signals of the two rows for the processing. For example, in the case where the ranging device 1 performs the ranging processing on a row basis as in the sequential flash method, even when the method of calculating the logical sum is employed, the loss of the pixel information due to calculating the logical sum can be avoided.

According to the present embodiment, as in the first embodiment, the ranging device 1 capable of reducing loss of information of incident light is provided. In addition, in the present embodiment, since the pixels 120 in a plurality of rows share the time counting unit 14 and the pixel information generation unit 15 and the scale of the circuit can be reduced, the size of the ranging device 1 can be reduced.

### Fourth Embodiment

Although FIG. 5 of the first embodiment exemplarily illustrates a configuration in which a plurality of pixels 120 is arranged in one row in the light receiving unit 12, the pixels 120 connected to one shift register may be all or a part of the pixels 120 included in one row. In this embodiment, a configuration example in which a part of the pixels 120 in one row is connected to one shift register will be described. In addition, in the present embodiment, two time counting units 14-1 and 14-2 (first time counting unit and second time counting unit) and two pixel information generation units 15-1 and 15-2 (first pixel information generation unit and second pixel information generation unit) are arranged for pixels 120 of one row. Description of elements common to the first to third embodiments may be omitted or simplified as appropriate.

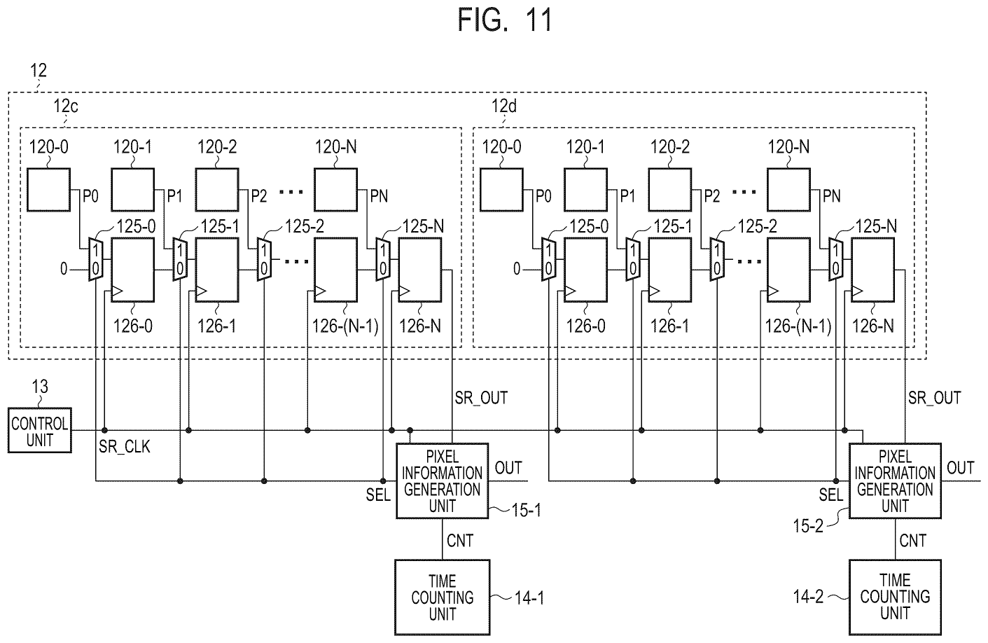

FIG. 11 is a diagram illustrating a configuration of the light receiving unit 12, the control unit 13, the time counting units 14-1 and 14-2, and the pixel information generation units 15-1 and 15-2 according to the present embodiment. The light receiving unit 12 includes a pixel block 12c and a pixel block 12d. Each of the pixel block 12c and the pixel block 12d includes the same element as the light receiving unit 12 of the first embodiment. The light receiving unit 12 includes pixels 120 arranged in one or more rows and a plurality of columns. The pixel block 12c includes a part of pixels 120 in one row. The pixel block 12d includes another part of pixels 120 in the same one row as the pixel block 12c. The plurality of selectors 125 and the plurality of registers 126 are arranged so as to respectively correspond to the plurality of pixels 120, as in the first embodiment. That is, the pixels 120 in the pixel block 12c and the pixels 120 in the pixel block 12d are processed by different shift registers. The control unit 13 outputs the clock signal SR_CLK to the registers 126 of the pixel block 12c, the registers 126 of the pixel block 12d, and the pixel information generation units 15-1 and 15-2.

The output terminal of the register 126-N of the pixel block 12c and the output terminal of the register 126-N of the pixel block 12d are connected to different pixel information generation units 15-1 and 15-2, respectively. That is, the light reception count values from the pixels 120 in one row are input to different pixel information generation units 15-1 and 15-2 for each pixel block.

According to the present embodiment, as in the first embodiment, the ranging device 1 capable of reducing loss of information of incident light is provided. Further, in the present embodiment, since the pixels 120 in one row are processed by a plurality of shift registers, the frequency of the clock signal SR_CLK can be lowered, and the signal processing can be facilitated. In addition, in the present embodiment, the plurality of time counting units 14-1 and 14-2 and the plurality of pixel information generation units 15-1 and 15-2, which are different for each pixel block, are arranged for the pixels 120 in one row. This makes it possible to reduce the number of pixels 120 to which one set of the time counting unit 14 and the pixel information generation unit 15 are connected, thereby facilitating signal processing.

### Fifth Embodiment

The fourth embodiment illustrates an example in which two time counting units 14-1 and 14-2 and two pixel information generation units 15-1 and 15-2 are arranged for one row of pixels 120. However, the number of the time counting units 14 and the number of the pixel information generation units 15 arranged for the pixels 120 in one row are not limited thereto. For example, one time counting unit 14 and one pixel information generation unit 15 may be arranged for pixels 120 of one row. In the present embodiment, a configuration example in which one time counting unit 14 and one pixel information generation unit 15 are arranged for pixels 120 of one row will be described. Description of elements common to the first to fourth embodiments may be omitted or simplified as appropriate.

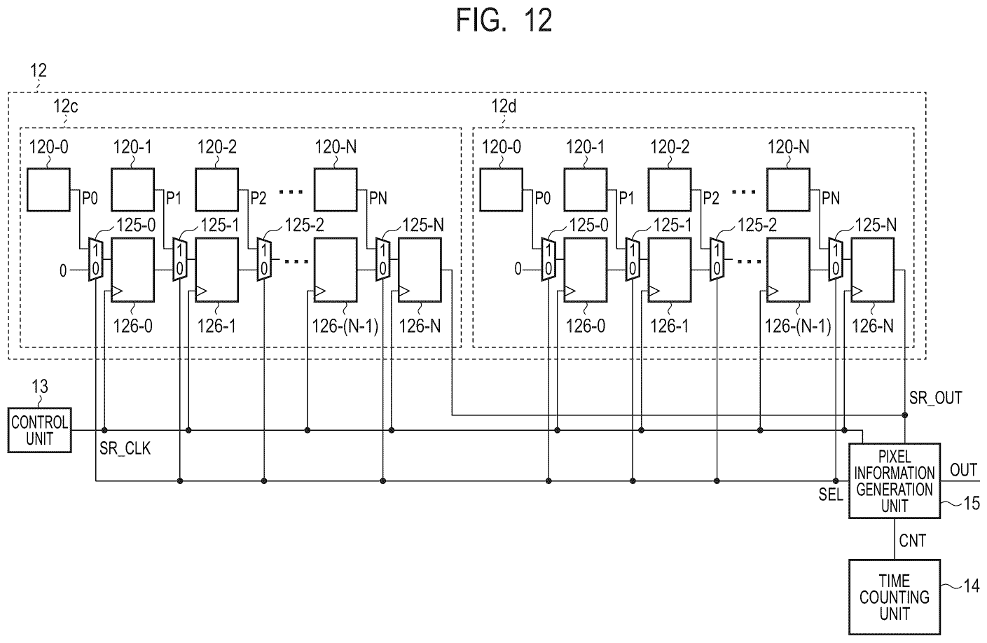

FIG. 12 is a diagram illustrating a configuration of the light receiving unit 12, the control unit 13, the time counting unit 14, and the pixel information generation unit 15 according to the present embodiment. The difference from FIG. 11 is that the number of the time counting units 14 and the number of the pixel information generation units 15 are changed to one, and the other points are the same as those in FIG. 11.

The output terminal of the register 126-N of the pixel block 12c and the output terminal of the register 126-N of the pixel block 12d are both connected to a common pixel information generation unit 15. That is, the light reception count values from the pixels 120 of the pixel block 12c and the light reception count values from the pixels 120 of the pixel block 12d are input in parallel to the common pixel information generation unit 15. Therefore, one set of the time counting unit 14 and the pixel information generation unit 15 is shared by the two pixel blocks 12c and 12d.

The pixel information generation unit 15 may sequentially process the light reception count values of the two pixel blocks 12c and 12d one by one, or may process the light reception count values in parallel. Signals may be simultaneously output from the registers 126-N of the two pixel blocks 12c and 12d. Even in such a case, the pixel information generation unit 15 sequentially processes the light reception count values of the two pixel blocks 12c and 12d one by one, or processes the light reception count values in parallel, so that the loss of pixel information can be avoided. Alternatively, the pixel information generation unit 15 may assign identification information to the pixel information and then output the pixel information of the pixels 120 of any one of the pixel blocks 12c and 12d.

According to the present embodiment, as in the first embodiment, the ranging device 1 capable of reducing loss of information of incident light is provided. Further, as in the fourth embodiment, since the pixels 120 in one row are processed by a plurality of shift registers, the frequency of the clock signal SR_CLK can be lowered, and the signal processing can be facilitated. Further, in the present embodiment, since the plurality of pixel blocks shares the time counting unit 14 and the pixel information generation unit 15 and the scale of the circuit can be reduced as compared with the fourth embodiment, the size of the ranging device 1 can be reduced.

### Sixth Embodiment

In the third embodiment, the pixels 120 in a plurality of rows share the time counting unit 14 and the pixel information generation unit 15. In the fourth embodiment, the pixels 120 in one row are processed by the plurality of shift registers, the plurality of time counting units 14-1 and 14-2, and the plurality of pixel information generation units 15-1 and 15-2. In the present embodiment, the configuration of the third embodiment and the configuration of the fourth embodiment are combined. Description of elements common to the first to fifth embodiments may be omitted or simplified as appropriate.

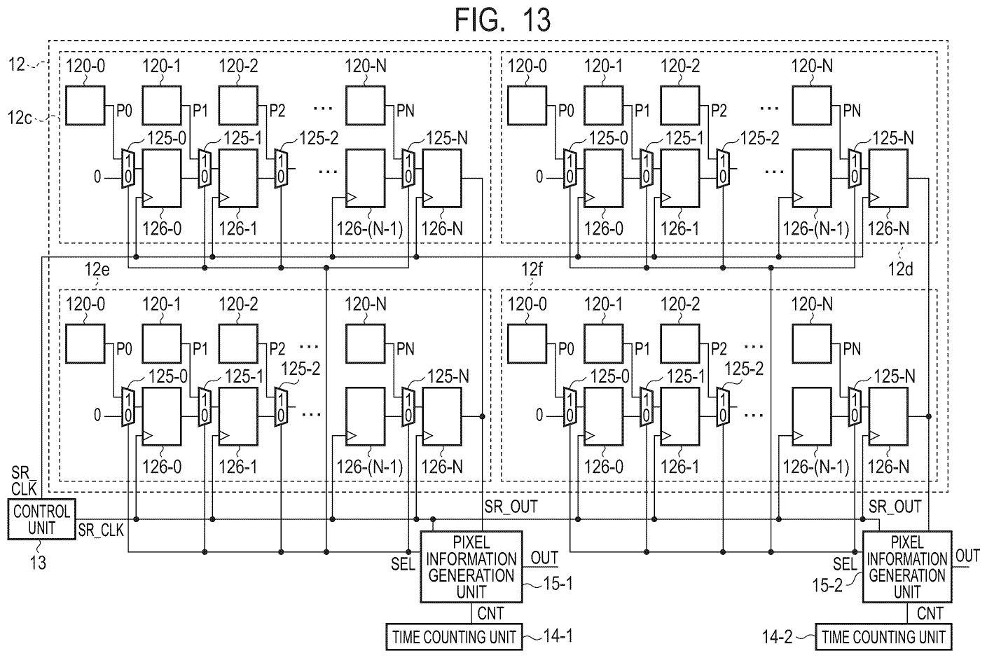

FIG. 13 is a diagram illustrating a configuration of the light receiving unit 12, the control unit 13, the time counting units 14-1 and 14-2, and the pixel information generation units 15-1 and 15-2 according to the present embodiment. The light receiving unit 12 includes a pixel block 12e and a pixel block 12f in addition to the pixel block 12c and the pixel block 12d similar to those of the fourth embodiment. Each of the pixel blocks 12c, 12d, 12e, and 12f includes elements similar to those of the light receiving unit 12 of the first embodiment. The light receiving unit 12 includes pixels 120 arranged in a plurality of rows and a plurality of columns. The plurality of rows includes a first row and a second row. The pixel block 12c includes a part of the pixels 120 in the first row. The pixel block 12d includes another part of the pixels 120 in the first row. The pixel block 12e includes a part of the pixels 120 in the second row. The pixel block 12f includes another part of the pixels 120 in the second row. The plurality of selectors 125 and the plurality of registers 126 are arranged so as to respectively correspond to the plurality of pixels 120, as in the first embodiment. That is, the pixels 120 in the pixel block 12c, 12d, 12e, and 12f are processed by different shift registers. The control unit 13 outputs the clock signal SR_CLK to the registers 126 of the pixel blocks 12c, 12d, 12e, and 12f and the pixel information generation units 15.

The output terminal of the register 126-N of the pixel block 12c and the output terminal of the register 126-N of the pixel block 12e are both connected to a common pixel information generation unit 15-1. That is, the light reception count values from the pixels 120 in the two rows are input to the common pixel information generation unit 15-1. Therefore, the time counting unit 14-1 and the pixel information generation unit 15-1 are shared by two rows.

The output terminal of the register 126-N of the pixel block 12d and the output terminal of the register 126-N of the pixel block 12f are both connected to a common pixel information generation unit 15-2. The pixel information generation unit 15-2 to which the pixel blocks 12d and 12f are connected is a circuit different from the pixel information generation unit 15-1 to which the pixel blocks 12c and 12e are connected. That is, the light reception count values from the pixels 120 in one row are input to the plurality of pixel information generation units 15-1 and 15-2 that are different for each pixel block.

According to the present embodiment, as in the first embodiment, the ranging device 1 capable of reducing loss of information of incident light is provided. Further, as in the third embodiment, since the pixels 120 in one row are processed by a plurality of shift registers, the frequency of the clock signal SR_CLK can be lowered, and the signal processing can be facilitated. Further, as in the third embodiment, a plurality of time counting units 14-1 and 14-2 and a plurality of pixel information generation units 15-1 and 15-2, which are different for each pixel block, are arranged for each pixel 120 in one row. This makes it possible to reduce the number of pixels 120 to which one set of the time counting unit 14 and the pixel information generation unit 15 are connected, thereby facilitating signal processing. In addition, as in the fourth embodiment, since the pixels 120 in the plurality of rows share the time counting unit 14 and the pixel information generation unit 15 and the scale of the circuit can be reduced, the size of the ranging device 1 can be reduced. Therefore, both the effect of lowering the frequency of the clock signal SR_CLK and reducing the size of the ranging device 1 can be achieved.

### Seventh Embodiment

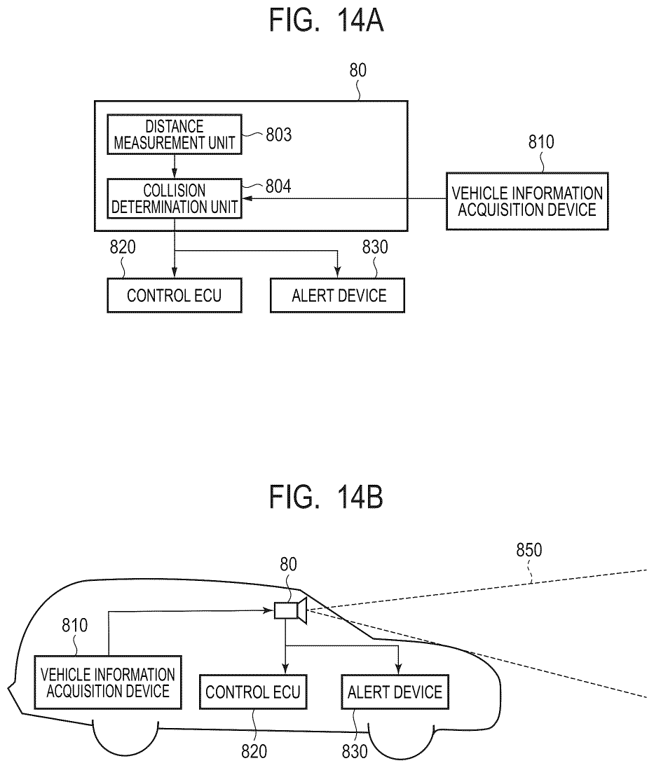

FIGS. 14A and 14B are block diagrams of equipment relating to an in-vehicle ranging device according to the present embodiment. Equipment 80 includes a distance measurement unit 803, which is an example of the ranging device of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 14B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present invention.

In the second embodiment, an example in which the shift register configured by the registers 151-1, 151-2, . . . 151-N is added to the configuration of the first embodiment is illustrated, but serial-to-parallel conversion using the shift register can also be applied to other embodiments. For example, the configuration of the pixel information generation unit 15 of the third to sixth embodiments may be replaced with the configuration of the pixel information generation unit 15 of the second embodiment.

In the first to sixth embodiments, a configuration in which the plurality of pixels 120 arranged in one row is connected to one shift register is exemplified, but the arrangement of the plurality of pixels 120 is not limited thereto. For example, a plurality of pixels 120 arranged in one column may be connected to one shift register.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present invention, and the technical scope of the present invention should not be construed as being limited by the embodiments. That is, the present invention can be implemented in various forms without departing from the technical idea or the main features thereof.

According to the present invention, it is possible to provide a ranging device capable of reducing loss of information of incident light.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-128388, filed Aug. 7, 2023, which is hereby incorporated by reference herein in its entirety.

What is claimed is:

1. A ranging device comprising:
a time counting unit configured to output a time count value indicating an elapsed time from a start of time counting;
a light receiving unit including a plurality of pixels and configured to output a light reception count value of incident light to each of the plurality of pixels; and
a pixel information generation unit configured to output pixel information in which the light reception count value and the time count value are associated with each other for each pixel,
wherein the pixel information generation unit acquires the light reception count value of each of the plurality of pixels and outputs the pixel information of each of the plurality of pixels within a period of time equal to or less than a time in which the time count value changes by a predetermined value.

2. The ranging device according to claim 1, wherein the predetermined value is one.

3. The ranging device according to claim 1 further comprising a control unit configured to synchronously control a light emission timing of a light emitting unit that emits light and a start timing of the time counting.

4. The ranging device according to claim 1, wherein the light receiving unit further includes a shift register configured to hold the light reception count value corresponding to each of the plurality of pixels.

5. The ranging device according to claim 4, wherein the shift register includes a sequential circuit corresponding to each of the plurality of pixels.

6. The ranging device according to claim 4, wherein the shift register sequentially outputs the light reception count value corresponding to each of the plurality of pixels in response to a pulse of a clock signal.

7. The ranging device according to claim 6, wherein a period of the pulse of the clock signal is shorter than a period in which the time count value changes.

8. The ranging device according to claim 6, wherein the number of pulses of the clock signal that is input in a period in which the time count value is a constant value is equal to the number of pixels corresponding to the pixel information.

9. The ranging device according to claim 4 further comprising a selector configured to switch between a first state in which the light reception count value is output from each of the plurality of pixels to the shift register and a second state in which the light reception count value held in the shift register is shifted.

10. The ranging device according to claim 9, wherein the selector performs switching from the first state to the second state at a timing when the time count value changes.

11. The ranging device according to claim 1, wherein the pixel information generation unit outputs the pixel information of each of the plurality of pixels in parallel.

12. The ranging device according to claim 11, wherein the pixel information generation unit includes a generation processing unit configured to sequentially output the pixel information for each pixel, and a serial-to-parallel conversion circuit configured to perform serial-to-parallel conversion of the pixel information.

13. The ranging device according to claim 12, wherein the serial-to-parallel conversion circuit includes a shift register.

14. The ranging device according to claim 1,
wherein the plurality of pixels is arranged to form a plurality of rows and a plurality of columns,
wherein the plurality of rows includes a first row and a second row, and
wherein the light reception count value of a pixel in the first row and the light reception count value of a pixel in the second row are input to the pixel information generation unit.

15. The ranging device according to claim 1,
wherein the plurality of pixels is arranged to form a plurality of rows and a plurality of columns, and
wherein the light reception count value of a part of pixels included in one row and the light reception count value of another part of the pixels included in the one row are input in parallel to the pixel information generation unit.

16. The ranging device according to claim 1 comprising a plurality of the pixel information generation units,
wherein the plurality of pixels is arranged to form a plurality of rows and a plurality of columns,
wherein the light reception count value of a part of pixels included in one row is input to a first pixel information generation unit of the plurality of pixel information generation units, and
wherein the light reception count value of another part of the pixels included in the one row is input to a second pixel information generation unit of the plurality of pixel information generation units.

17. The ranging device according to claim 1 comprising a plurality of the pixel information generation units,
wherein the plurality of pixels is arranged to form a plurality of rows and a plurality of columns,
wherein the plurality of rows includes a first row and a second row,
wherein the light reception count value of a part of pixels in the first row and the light reception count value of a part of pixels in the second row are input in parallel to a first pixel information generation unit of the plurality of pixel information generation units, and
wherein the light reception count value of another part of the pixels in the first row and the light reception count value of another part of the pixels in the second row are input in parallel to a second pixel information generation unit of the plurality of pixel information generation units.

18. The ranging device according to claim 16 comprising a plurality of the time counting units,
wherein a first time counting unit of the plurality of time counting units outputs the time count value to the first pixel information generation unit, and
wherein a second time counting unit of the plurality of time counting units outputs the time count value to the second pixel information generation unit.

19. The ranging device according to claim 1 further comprising a frequency distribution generation unit configured to generate a frequency distribution indicating a frequency of the light reception count value at each time count value based on the pixel information.

20. A movable body comprising:
the ranging device according to claim 1;
a distance information acquisition unit configured to acquire distance information to an object from the pixel information; and
a movable body control unit configured to control the movable body based on the distance information.
